(19) United States
(12) Patent Application Publication
(10) Pub. No.: US 2004/0012832 A1
(43) Pub. Date: Jan. 22, 2004

(54) Beam expansion

(76) Inventors: Niall Anthony Gallen, Cambridge (GB); Timothy York, Gloucestershire (GB); Adrian Robert Leigh Travis, Wrangton (GB)

Correspondence Address: Don W Bulson Esq, Renner Otto Boisselle & Sklar LLP, 1621 euclid avenue, 19th floor, Cleveland, OH, 44115, US

(21) Appl. No.: 10/398,972

(22) PCT Filed: Oct. 11, 2001
(86) PCT No.: PCT/GB01/04528

(30) Foreign Application Priority Data
Oct. 11, 2000 (GB) 00249458

(51) Int. Cl. G02B 5/32

(52) U.S. Cl. 359/15

(57) ABSTRACT

A large-area collimated beam of radiation is formed by re-directing a beam of small projected area off one or two orthogonal surfaces which are faceted or have a non-specular reflection angle and which spatially distribute the incoming beam across their surface area. Preferably there are two expansion stages, one for each dimension. If the input beam is linearly polarised then the output beam will also be polarised. The polarisation will undergo a rotation through 90 degrees. The beam expander is compact and suitable for use in liquid-crystal flat-panel displays.

The present invention concerns the production of a beam of light of large cross-sectional area. Such a beam is useful in particular for displays, and the invention was conceived in connection with PL-LCDs (photoluminescent liquid-crystal displays), as described for instance in WO 95/27920 (Crossland et al). Here UV light is input to a liquid-crystal modulator which applies image information to the light; the modulated UV light then strikes a RGB phosphor panel to produce a colour display.

To take best advantage of such a system the input light, normally near-visible UV or blue light, should be more or less parallel. This gives better electro-optic performance and minimises crosstalk problems (i.e. light from a given modulator pixel striking the wrong phosphor). A wide angle of view of the ultimate image, normally desirable in displays, is ensured by the near-Lambertian emission characteristics of the phosphors themselves, independently of the input UV light.

A large-area collimated source can be produced by collimating the light from a two-dimensional array of point sources with a corresponding array of lenses. The point sources can perhaps be produced by masking a diffuse source. However, this arrangement is inefficient and entails problems of alignment.

The invention relates to the expansion in two dimensions of a well-defined collimated beam of light, which may or may not be apertured. The collimated beam is formed from a point source that has been collimated before being sent through the device of the invention. The idea is related to the reflection of a small two-dimensional beam of light from a large surface area, which is positioned such that the normal to the plane of the reflecting surface is at an angle to the normal to the projected area of the beam. This results in the smaller area of the plane of the collimated wavefront of uniform (or nearly uniform) intensity impinging on the larger area and being distributed across the larger area.

According to the invention there is provided a collimated light generator for producing a large-area beam of collimated light from a narrow beam, comprising two stages of tapered reflecting surface, the first reflecting the beam in such a way as to expand it in one dimension, and the second reflecting it in such a way as to expand it in an orthogonal dimension so as to produce a two-dimensionally expanded beam.

The tapered surfaces can be, for instance, a series of angled specular facets in a sawtooth formation, essentially splitting the beam into a set of parallel reflected sub-beams. Each of these is then itself split by the second stage to produce a two-dimensional array of sub-beams. Alternatively the tapered reflectors can have surfaces with diffraction gratings bringing about the desired re-direction of the beam.

The input beam can conveniently be produced by a laser, but any small-area source can be used. The light source can be used in liquid-crystal displays, but also for general illumination or for other kinds of modulator.

For a better understanding of the invention embodiments of it will now be described, by way of example, with reference to the accompanying drawings, in which:

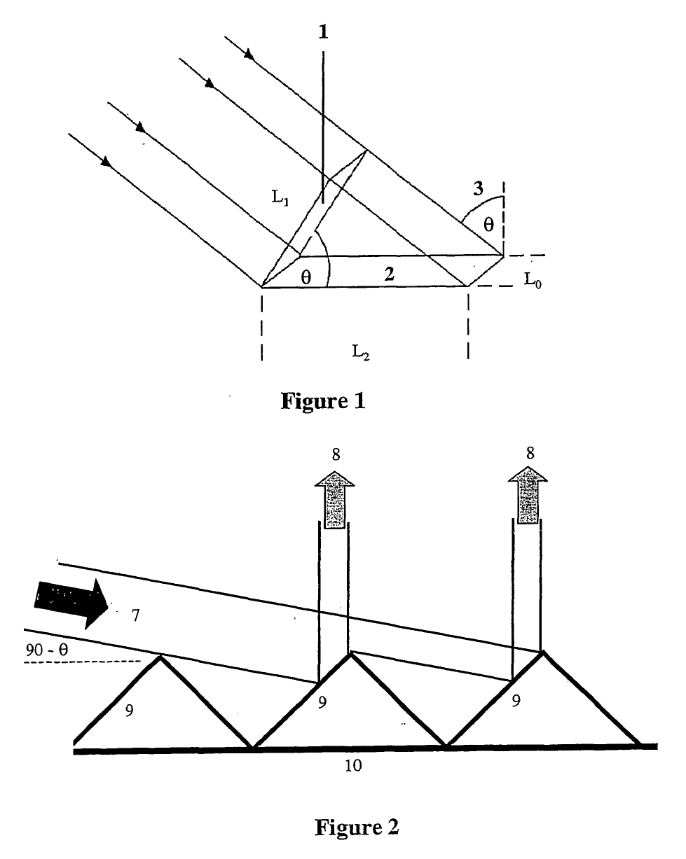

FIG. 1 shows the projection of an area through an angle;

FIG. 2 shows the re-direction of incident radiance by a faceted reflecting surface;

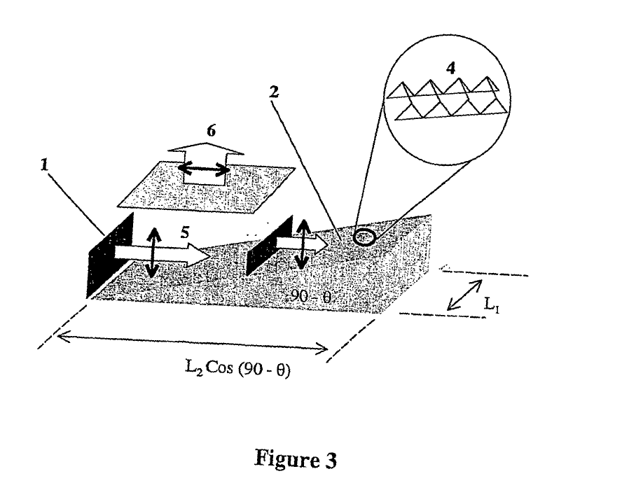

FIG. 3 shows the expansion of a collimated beam maintaining polarisation and rotating it;

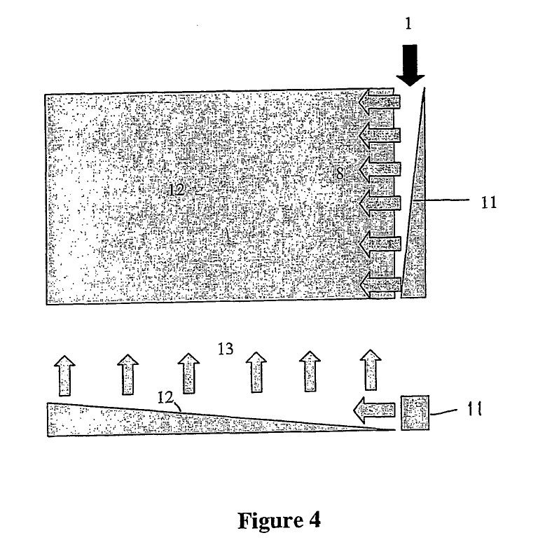

FIG. 4 shows two beam-expanding tapers placed orthogonal to one another, in accordance with the invention;

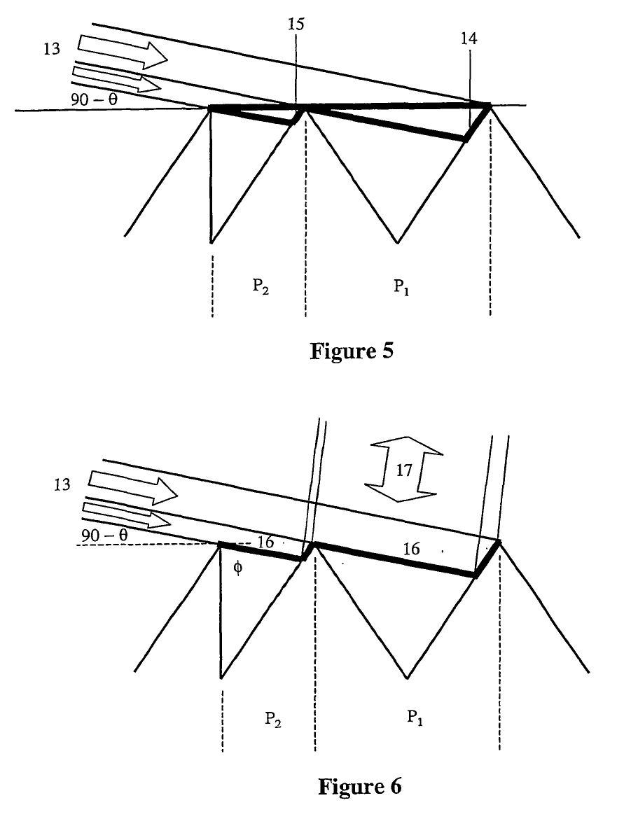

FIG. 5 shows the effect of changing the pitch of the reflecting facets;

FIG. 6 shows an arrangement similar to FIG. 5 but with further reflecting facets;

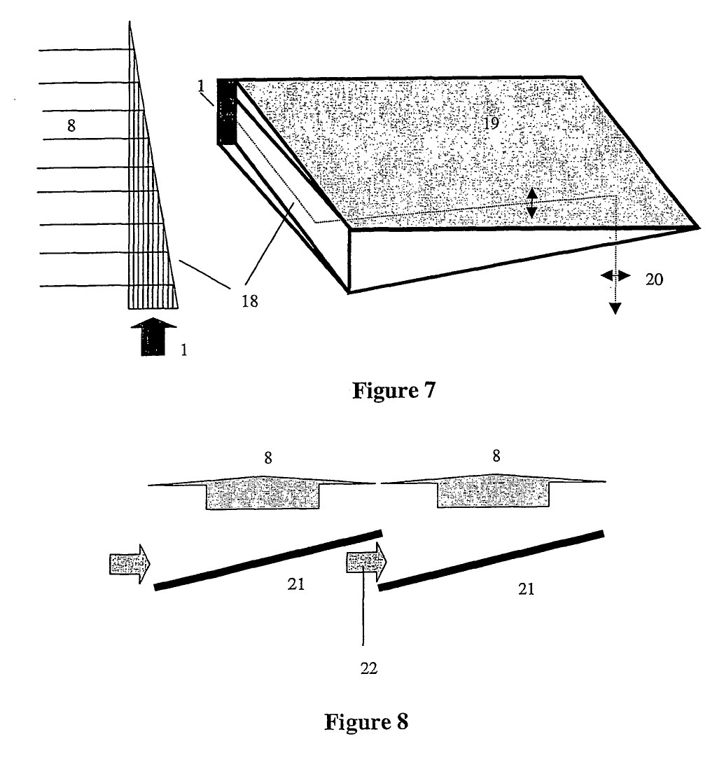

FIG. 7 shows an orthogonal tapered beam expander;

FIG. 8 shows an alternative embodiment;

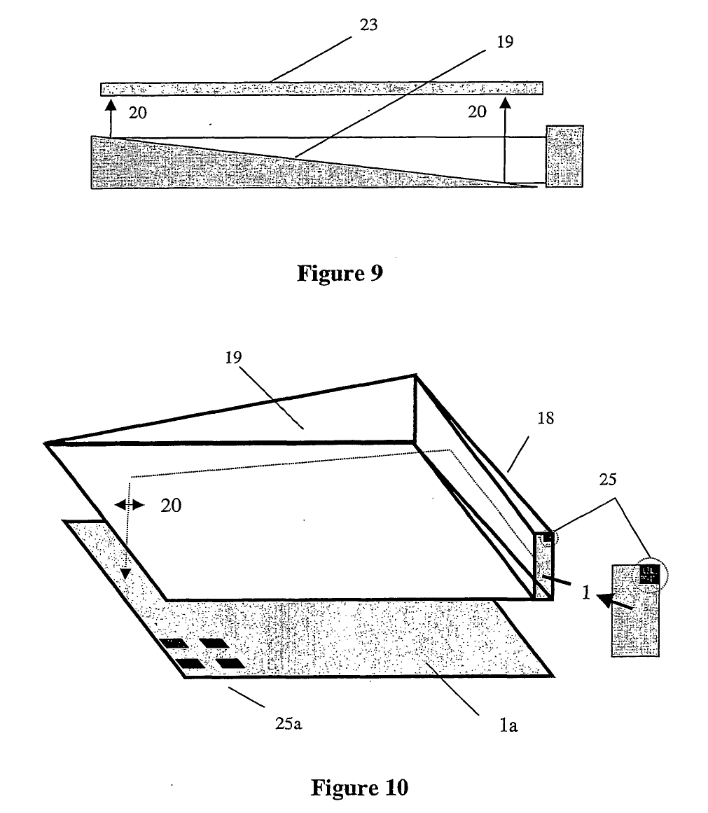

FIG. 9 shows the illumination of a display device using a beam expander of the invention;

FIG. 10 shows the expansion of a collimated two-dimensional source;

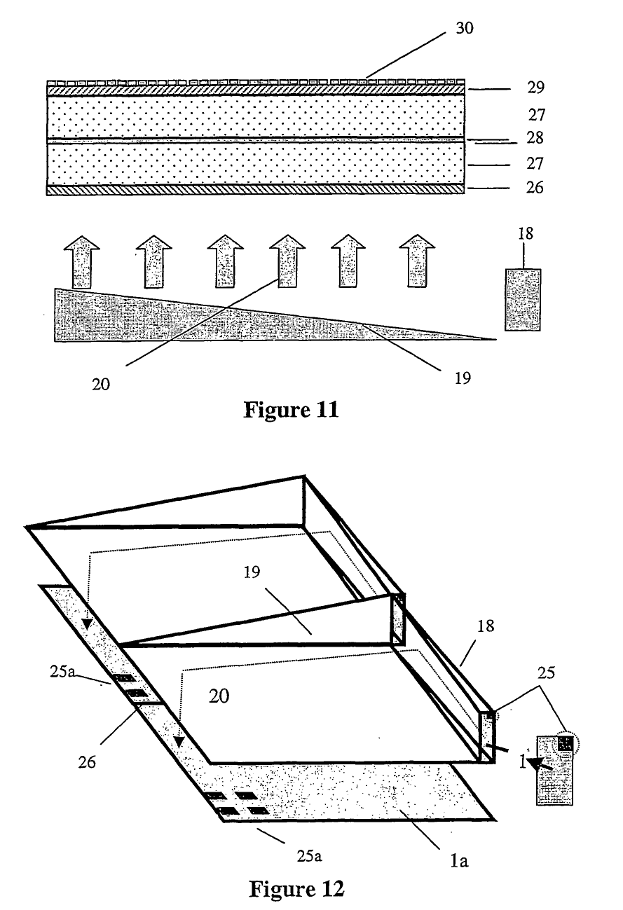

FIG. 11 shows an embodiment of the invention as applied to PLLCD devices;

FIG. 12 shows a variation of the embodiment of FIG. 10 using multiple panels;

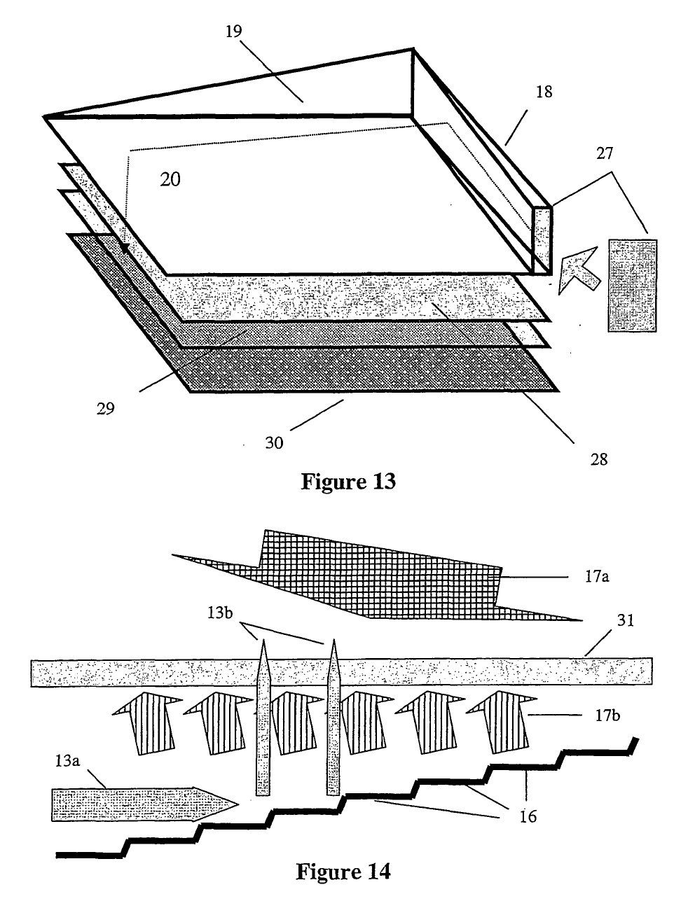

FIG. 13 shows an embodiment of the invention as used for fan-out of a beam; and

FIG. 14 shows an embodiment of the invention as applied to reflective displays.

For a collimated beam of flux Φ₀, which has a rectangular projected area A₁, defined as L₀ times L₁ (1 in FIG. 1), incident on a horizontal rectangle of dimensions L₀ times L₂ (2 in FIG. 1) and which has an area A₂ which is greater than A₁, the same flux Φ₀ will fall on a larger area. The flux in the projected area A₁ and that on A₂ are equal. That is,

Φ₀(A₁)=Φ₀(A₂) (i)

i.e.

E₁A₁=E₂A₂ (ii)

Where:

Φ₀(A₁) is the flux in the projected area A₁,

Φ₀(A₂) is the flux arriving at the surface of area A₁,

E₁ is the radiance of the collimated beam across A₁, and

E₂ is the radiance of the collimated beam across A₂.

If the angle defined by 3 in FIG. 1 is given the symbol θ (FIG. 1), then the relationship between A₁ and A₂ is given by geometry as

A₁=A₂ Cosθ (iii)

giving

E₂=E₁ Cosθ (iv)

This is a form of Lambert's law. In this way a small rectangular collimated beam can be made to impinge on a much larger area by making θ large and hence E₂ small. If the radiation impinges on a flat reflecting surface then the projected area of the reflected beam is returned to the original A₁, according to the symmetry of the situation and the laws of reflection. Notice that one of the dimensions of the two rectangles is equal (L₀) so that the expansion at the surface occurs only in the other dimension (L₁/L₂). If the surface is faceted, the original small beam-projected area A₁ can be locally re-directed at different positions on A₂ along L₁. In this way a well-defined collimated intense beam of small dimensions can be re-directed by reflection after having being split up or spread over a larger area. The facets are in this example made to be a series of equally spaced parallel planes, which are angled with respect to A₂ as shown in FIG. 2. From equation (ii), the radiance per unit area on a flat reflecting surface is

E₂=(E₂A₂)/A₁. (v)

For N facets, the fraction of the radiation reflected by each of the facets is E₂/N. A sectional view of a portion of the incident radiation, 7, is shown in FIG. 2 to be incident on a surface comprising a series of parallel facets (9), at an angle θ. The parallel facets extend into the page.

Note that if the input beam projected area is not perfectly collimated, the same argument can be applied for each radiance angle individually.

The facets are along a fraction of L₂ as described in FIG. 1. In this the fraction of the area of the incoming beam Δa (7) is spread across two individual facets 9 and re-directed by reflection from the angled surface such that Δa is split into two collimated beams which are spatially separated.

FIG. 3 shows a single faceted taper (or angled surface) with angle θ with respect to the normal to the projected area of the collimated beam with which it is illuminated. This collimated beam may comprise linearly polarised radiation, as is shown in FIG. 3. As each fraction of the beam is incident on the faceted surface, it is re-directed and spatially separated according to the separation of adjacent facets. L₂ is depicted in terms of the angle of incidence of the incident radiation with respect to the faceted surface.

FIG. 4 shows the complete scheme in section and in plan. The projected area of the original collimated beam 1 is incident on a faceted surface 11 at an angle to the normal of the surface and re-directed by facets to produce a series of reflected beams 8. This re-directed radiation is then incident on a second angled surface with facets 12, which again re-directs the radiation into a series of reflected beams 13.

The facets may be of dimensions such that the areas receiving the incident radiation and the distance between these areas are small in comparison to the smallest area they are intended to illuminate. For instance, in illuminating a two-dimensional array of pixels, the pitch of the reflecting facets as depicted in FIG. 5 (P₁ or P₂ where the distances are measured between adjacent dashed lines) can be made to be smaller than any element in the array. The areas illuminated by the incoming beam 13 in FIG. 5 (14 for P₁ and 15 for P₂) represent different fractions of the total area of the facetted surface and are two examples given of the possible structure. However, it can be shown by equivalent triangles (shaded areas in FIG. 5) that for half the pitch (P₂) the area is half that of the larger pitch (P₁) which means that the same radiation is reflected from two facets of pitch P₂ as from one facet of pitch P₁. From FIG. 5, both triangles have one angle equal to 90°−θ and another angle defined by the slope of the reflecting facets (which are equal for both pitches). Since one of the sides of one triangle is twice that of the other (P₁=2P₂) the area illuminated for the larger pitch case can be shown to be twice that of the smaller pitch case.

FIG. 6 shows a different form of the facets for two pitches. In this case the reflecting facets are as in FIG. 5 but the structure in between each of the areas of the facets receiving a portion of the incident radiation is now made to be parallel to the incident beam direction 13. These parts are shown as thick black lines 16. This is another form of the facets. The angle φ can range from 0 to θ, where θ is the angle of incidence with respect to the normal to the plane of the facet array as before. The form depicted in FIG. 6 has the advantage that with the entire surface being reflective then the structure can behave as a faceted plane mirror for radiation arriving on the surface 17. This can be used to return ambient light in a reflective-type display while allowing illumination of the same display in low light level environments. Alternatively the areas 16 between the reflecting facets can be made to be absorbing to reduce scatter or ambient reflections through a device.

FIG. 7 shows two orthogonal tapers which expand the input beam of rectangular projected area 1 by reflection from a structure which re-directs the radiation, in a direction other than would be achieved using a plane surface 8, using first one surface 18 and then another 19. These surfaces may or may not be orthogonal. The surfaces can be faceted as before (FIGS. 3 to 6) or may be in the form of reflection-type diffraction gratings (blazed or unblazed) or in the form of holographic reflection or Bragg gratings. Note that the rotation of a linearly polarised input beam of radiation is shown in the diagram at 20.

FIG. 8 shows how a series of the devices can be nested in order that a high-intensity large-area source can be achieved from several small-area sources. The primary expanders together produce a continuous input into a large secondary expander, achieved by using angled planes instead of a taper so that the source for one primary expander can be located beneath the adjacent angled plane. In the diagram the small sources 22 illuminate corresponding tapers 21 while situated beneath a second taper. This allows the production of a composite seamless large area output using a series of small sources. In this case the taper is produced by angling a surface.

FIG. 9 shows the device used to illuminate an array of shutters 23 such as those utilised in display devices. A small collimated source is spread over the entire input plane of the pixellated light valve. The collimation can be relaxed slightly to get a uniform irradiance. For the PLLCD this is not as important, because radiation arriving at the phosphor causes diffuse emission. In particular in PLLCD devices, light from an ultra-violet emitter may be expanded and directed through the liquid-crystal layer. This can have the beneficial effect of improving the optical response of the liquid crystal. Radiation that is allowed to pass through the liquid-crystal layer will impinge upon the screen phosphors and excite them to lambertian emission. In a conventional liquid-crystal device a diffuser could be used on the screen to increase the narrow viewing angle associated with the high degree of collimation, if required.

FIG. 10 shows how a pixellated input produces an axially transposed pixellated image at output. Each area in the plane 1 of the source is mapped to an associated position in the output plane 1a. If the viewer is looking such that the arrows in the diagram are arriving towards the eye then the image is reversed from left to right. In this way, given an appropriate input (i.e. axially reversed), an image can be expanded using the invention. In this way complete images can be expanded from, for example, a reflective fast bit plane device. This is depicted in the figure where four pixels are represented as four square blocks 25 which are expanded to produce spatially separated pixels 25a after being reflected through the expansion system, i.e. reflected at surfaces 18 and 19.

The embodiment comprises a small-area modulating means that forms a miniature collimated image which is expanded by application of the orthogonal-taper beam expansion assembly. The image formed using the modulating means may be a colour image using a colour pixellated image or a monochromatic image which may or may not be in the ultra-violet. A diffusing screen or phosphor screen is arranged at the output plane of the device. This is shown schematically in FIG. 10. The image that is input into the beam expansion system 1 contains the information that is to be displayed. Note that the modulation positions in the input plane 25 become spatially separated in the output plane 25a for a simple facetted reflection configuration. This is acceptable if the pitch, or distance between such pixellated positions, in the output plane is smaller than the required pitch.

In all of the foregoing the output radiation was depicted as leaving the reflecting structures parallel to the normal of the surface. This need not be the case, though it makes it easier to produce a compact flat source. The angle chosen for the reflection is a function of the design of the reflecting/re-directing surfaces and the input angle of incidence. In some instances the output may be required to be collimated but at an angle to the normal of the final reflecting surface. The first or second reflecting surfaces 18, 19 may be used to produce different spatial and angular distributions using refractive, diffractive or holographic structures that are different at different positions across the surfaces. As an example, the collimated beam arriving at the second surface 19 in FIG. 7 from the first re-directing surface 18 could be made to be focussed into an array of spots.

It is also possible to make use of the reversibility of a non-diffusing optical system by having embodiments of the invention in which a large-area collimated beam is incident on the second surface 19. The fraction that impinges on the reflective facets or holographic reflecting surface will be redirected to the first surface 18. From this surface a concentrated beam of radiation, that may or may not contain spatial information as in FIG. 10, is produced.

The input light may be less than perfectly collimated. That is to say it may have an angular distribution. The output from the first and second face will reflect this distribution: by having an angular distribution in the case of the faceted reflector and having an angular distribution and efficiency of re-direction in the case of diffraction or holographic gratings. The input radiation may or may not be made to cover the reflecting surfaces completely.

The device, including two spatially arranged angled surfaces such that there-direction from both their surfaces results in an expansion of the input beam's projected area and its spatial distribution in two dimensions, including two sets of angled surfaces each of which expand the input beam's projected area and spatial distribution in one dimension, can be used in conjunction with optical elements which collect and manipulate the output. As an example, a collimated output impinging on an array of lenses would result in an array of focussed spots.

All of the foregoing is relevant to the illumination of a shutter-array-based display device such as a liquid crystal. In particular, the PL-LCD device, which uses a narrow range of excitation wavelengths, may use a single point source expanded to cover all or part of the display area. Several point sources can be expanded as described here and placed side by side to form one large-area source. Specific applications for the expander will now be described.

In the embodiment of FIG. 11 a device such as has been described in the preceding text is used in the PLLCD architecture. The device is used to expand an intense ultra-violet source which emits radiation in the region 350 nanometres to 410 nanometres. This expanded beam is positioned behind a modulator M as depicted in FIG. 11. Modulation of the expanded source occurs when it is passed through the combination of layers comprising a polarising layer 26, a liquid-crystal layer 28 sandwiched between two transparent layers 27, a second polariser 29 which is used as an analyser for the modulated radiation and a pixellated phosphor or non-pixellated layer 30 onto which the transmitted modulated radiation signal is incident. By modulating the polarisation direction of the radiation from the source which is transmitted through the polariser 26 the transmission is spatially varied according to the image required at the phosphor layer which may be monochromatic or polychromatic. More than one orthogonal-taper beam expander may be used together to cover the input plane of the modulation scheme. For example the method described in FIG. 8 can be used to illuminate the entire display input plane by illuminating separate areas of the plane using the expanded output of more than one ultra violet source.

FIG. 12 shows a variation of the device of FIG. 10, in which an optical surface which locally diverges the radiation is used. Two such expanded images can be placed side by side so that a tiled composite image is formed. In the Figure one expansion unit with expanded image 25a of the small input 25 is labelled as before. Behind this is shown a second expansion unit which also produces an image 25a′. A light source plane 1 is placed at the input corner of each expansion unit, accessible via the space behind the taper. The two expanded images are separated by a seam 26 corresponding to the line along which the two units are made to be in contact. In this way a series of expanded images can be used to form a larger image.

Another embodiment of the device is as a component in the generation of an array of outputs from a single input. This is illustrated in FIG. 13 where the input beam of radiation 27 takes the form of a well defined collimated planar wavefront and is reflected/re-directed through the beam expansion component at surfaces 18 and 19 as before. The output is depicted as a large-area plane 28 which is allowed to pass through an optical layer 29 which has, in the Figure, a regular function and which focuses the output from the beam-expanding device to an array of points in a plane 30. An example of the usefulness of such a system would be the generation of an array of inputs of equivalent wavelength and energy which are spatially distributed across a plane for input into a fan-out/fan-in optical switching mechanism.

Alternatively, the intensity of the original beam 27 can have a large number of grey-scales imposed on it if the optical element 29 is an array of optical modulators. In this way information can be written to the beam which can then undergo further information processing.

Another embodiment is the use of the beam expander for the illumination of a reflective display. Reflective displays are defined as those displays which use illumination from their surroundings to produce information on a screen. One means of achieving this is to reflect light selectively by mechanical means such as a micro-mirror device at required positions across the display area, thereby producing the image. Such a component may be called dynamic. A static version may also exist, e.g. a watch face. The watch front face may be designed to reflect selectively at particular angles or directions without any ability to choose and with no regard to any positioning across the display area.

These can be achieved in various ways all of which are schematically represented in FIG. 14 by an undefined component 31.

In both of the above a reflecting surface is required to redirect the ambient light towards the viewer. In low ambient light conditions, however, the contrast is greatly diminished and/or the display brightness decreases in visibility so that no useful information can be got from it. In these conditions it would be of very great use for the display to have a means of illumination. To this end the type of facetted structure explained in FIG. 6 is used, as represented in FIG. 14. The areas between the facets used for the beam expansion process are also reflective. Ambient light passes through the modulator layer 31 and is reflected as in a normal reflective display. However, when in a low ambient light, a source of light 13a can be used to illuminate the display by distributing the intensity across the viewing area 13b.

1. A light-directing device for producing a two-dimensional substantially collimated beam suitable for use in display devices, by the expansion in two directions of a small-area collimated source by reflection or re-direction of the radiation from the source, comprising two optically consecutive surfaces or sets of surfaces (12, 14), each expanding the cross-section of the radiation from the source in one direction.

2. A device according to claim 1, in which the surfaces are faceted reflective, diffractive or holographic large-area surfaces (14, 15), the illumination of the surfaces being at an angle such that the projected area of the beam is spread across the first surface and there-directed radiation from each part surface in turn is divided into spatially separated beams along one of the dimensions of each surface.

3. A device according to claim 1 or 2, in which the different positions over the area of the small-area source can be mapped, so that the expanded output is a magnified version of the input.

4. A device according to any preceding claim, in which the surfaces are angled with respect to one another so that the output beam is spread in two directions to form a large-area beam.

5. A device according to any preceding claim, in which the first surface expands the beam in one dimension and the second expands it in another direction, these dimensions being mutually orthogonal.

6. A device according to any preceding claim, in which a linearly polarised flux of a beam directed into the device maintains its polarisation and the polarisation will be rotated through 90 degrees after each re-direction, the resultant output beam being a large-area polarised beam.

7. A device according to any preceding claim and producing a spatially expanded beam comprising smaller beams of equal or near equal flux.

8. A device according to any preceding claim, in which the input radiation from the source is monochromatic.

9. A device according to any preceding claim and producing a spatially invariant beam expansion.

10. A beam source including a light source producing a narrow collimated beam and a light-directing device according to any preceding claim arranged to expand the beam in two dimensions.

11. A beam source according to claim 10, in which the radiation from the light source is coherent.

12. A liquid-crystal display using a device or a source according to any preceding claim.

13. An optical assembly using a device according to any of claims 1 to 9 in conjunction with a single or multiple optical element or an array of optical elements to spatially vary or direct or focus the output beam.

14. A method of producing a beam from a collimated point source or source of small dimensions with small angular divergence by expansion in two orthogonal directions by reflection or any form of re-direction by the two surfaces in turn to produce a large-area collimated beam, or large-area beam with small angular extent, which is a composite of a two-dimensional array of smaller collimated beams.

15. A method of obtaining a concentrated beam using a light-directing device as claimed in any of claims 1 to 9, wherein radiation is directed backwards through the device, in such a way that the optically consecutive surfaces each contract the cross section for the radiation from the surface in one direction.
